(19) United States
(12) Patent Application Publication
(10) Pub. No.: US 2006/0250670 A1
(43) Pub. Date: Nov. 9, 2006

(54) Image processing apparatus, image processing method, and image processing program

(75) Inventor: Taketo Tsukioka, Hachioji-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 11/485,204

(22) Filed: Jul. 12, 2006

Related U.S. Application Data
(63) Continuation of application No. PCT/JP05/00536, filed on Jan. 18, 2005.

(30) Foreign Application Priority Data
Jan. 19, 2004 (JP) 2004-010582

(51) Int. Cl. G06K 9/00; G06F 15/00

(52) U.S. Cl. 358/518; 358/504; 382/167; 358/1.9

(57) ABSTRACT

An image processing apparatus comprises a first correction section configured to correct a component of an input color signal represented by a plurality of components including a lightness component, the component to be corrected being other than the lightness component, and a parameter setting section configured to set parameters of the first correction section depending on the lightness component of the input color signal. The image processing apparatus further comprises an adjusted value calculation section configured to calculate an adjusted value for determining the final degree of color correction depending on one of the input color signal and a correction result of the first correction section, and a second correction section configured to correct the input color signal based on the correction result of the first correction section, input color signal, and adjusted value of the adjusted value calculation section and output a final color correction result.

### CROSS-REFERENCE TO RELATED APPLICATIONS

This is a Continuation application of PCT Application No. PCT/JP2005/000536, filed Jan. 18, 2005, which was published under PCT Article 21(2) in Japanese.

This application is based upon and claims the benefit of priority from prior Japanese Patent Application No. 2004-010582, filed Jan. 19, 2004, the entire contents of which are incorporated herein by reference.

### BACKGROUND OF THE INVENTION

1. Field of the Invention

The present invention relates to an image processing apparatus, an image processing method, and an image processing program capable of favorably controlling the color of a color image, particularly, a color image captured by a digital camera.

2. Description of the Related Art

An image captured by a consumer use digital camera often includes persons or landscape as a subject. The color of such an image, particularly, the color of person's skin, color of the sky or the like is required to be corrected satisfactorily. In order to meet this demand, there have been proposed techniques for selectively correcting specific color range in an image without generating color discontinuity.

For example, a technique disclosed in Japanese Patent Publication No. 2,994,665 determines how close an input RGB signal is to predetermined hue and brings the input RGB signal close to a predetermined target color signal in accordance with the similarity between the input RGB signal and predetermined hue.

### BRIEF SUMMARY OF THE INVENTION

According to a first aspect of the present invention, there is provided an image processing apparatus comprising:

a first correction section configured to correct a component of an input color signal represented by a plurality of components including a lightness component, the component to be corrected being other than the lightness component;

a parameter setting section configured to set parameters of the first correction section depending on the lightness component of the input color signal;

an adjusted value calculation section configured to calculate an adjusted value for determining the final degree of color correction depending on one of the input color signal and a correction result of the first correction section; and

a second correction section configured to correct the input color signal based on the correction result of the first correction section, input color signal, and adjusted value of the adjusted value calculation section and output a final color correction result.

According to a second aspect of the present invention, there is provided an image processing apparatus which performs color correction for an input color signal represented by a plurality of components including a lightness component, comprising:

first to N-th (N is an integer equal to or more than 2) color correction sections each configured to perform color correction for a specific color range, wherein

the first color correction section is configured to apply processing to the input color signal as an input color signal thereof,

the i-th (i is an integer from 2 to N) color correction section is configured to apply processing to an output from the (i−1)-th color correction section as an input color signal, and

each color correction section includes:
a first correction section configured to correct a component of a color signal input to the color correction section, the component to be corrected being other than the lightness component;
a parameter setting section configured to set parameters of the first correction section depending on the lightness component of the color signal input to the color correction section;
an adjusted value calculation section configured to calculate an adjusted value for determining the final degree of color correction depending on one of the color signal input to the color correction section and a correction result of the first correction section; and
a second correction section configured to correct the input color signal based on the correction result of the first correction section, color signal input to the color correction section, and adjusted value of the adjusted value calculation section and output a final color correction result.

According to a third aspect of the present invention, there is provided an image processing apparatus which performs color correction for an input color signal represented by a plurality of components including a lightness component, comprising:

first to N-th (N is an integer equal to or more than 2) color correction sections each configured to perform color correction for a specific color range; and

a final color correction section configured to output a final color correction result based on outputs of the respective color correction section and input color signal,

each of the color correction section including:
a first correction section configured to correct a component of the input color signal, the component to be corrected being other than the lightness component;
a parameter setting section configured to set parameters of the first correction section depending on the lightness component of the input color signal; and
an adjusted value calculation section configured to calculate an adjusted value for determining the final degree of color correction depending on one of the input color signal and a correction result of the first correction section, the color correction section outputting the correction result of the first correction section and adjusted value of the adjusted value calculation section.

According to a fourth aspect of the present invention, there is provided an image processing method comprising:

correcting a component of an input color signal represented by a plurality of components including a lightness component, the component to be corrected being other than a lightness component;

setting parameters for correction of the component other than the lightness component depending on the lightness component of the input color signal;

calculating an adjusted value for determining the final degree of color correction depending on one of the input color signal and a result of the correction; and

correcting the input color signal based on the correction result, input color signal, and adjusted value and outputting a final color correction result.

According to a fifth aspect of the present invention, there is provided an image processing program allowing a computer to execute processes of:

correcting a component of an input color signal represented by a plurality of components including a lightness component, the component to be corrected being other than a lightness component;

setting parameters for correction of the component other than the lightness component depending on the lightness component of the input color signal;

calculating an adjusted value for determining the final degree of color correction depending on one of the input color signal and a result of the correction; and

correcting the input color signal based on the correction result, input color signal, and adjusted value and outputting a final color correction result.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a configuration of a digital camera serving as an image processing apparatus according to a first embodiment of the present invention;

FIG. 2 is a view for explaining effect of hue rotation which is obtained by an affine transformation;

FIG. 3 is a view for explaining effect of saturation emphasis which is obtained by an affine transformation;

FIG. 4 is a view for explaining effect of hue uniformity which is obtained by an affine transformation;

FIG. 5 is a flowchart for explaining calculation method of a lightness-dependent affine transformation;

FIG. 6 is a view for explaining an interpolation calculation of affine transformation parameters;

FIG. 7 is a view for explaining a method of specifying a correction area;

FIG. 8 is a view for explaining a weighting function;

FIG. 9 is a view showing a configuration of a digital camera serving as an image processing apparatus according to a second embodiment of the present invention;

FIG. 10 is a view showing a configuration of a digital camera serving as an image processing apparatus according to a third embodiment of the present invention;

FIG. 11 is a view showing a configuration of a digital camera serving as an image processing apparatus according to a fourth embodiment of the present invention;

FIG. 12 is a view showing a setting example of the color correction area in an L*a*b* space;

FIG. 13 is a view showing a setting example of the color correction area in the case where four parameters of amin, amax, bmin, and bmax are made changeable depending on lightness L*′; and

FIG. 14 is a flowchart of image processing performed by software, which shows an image processing method and an image processing program according to a fifth embodiment of the present invention.

### DETAILED DESCRIPTION OF THE INVENTION

Preferred embodiments of the present invention will be described below with reference to the accompanying drawings.

### First Embodiment

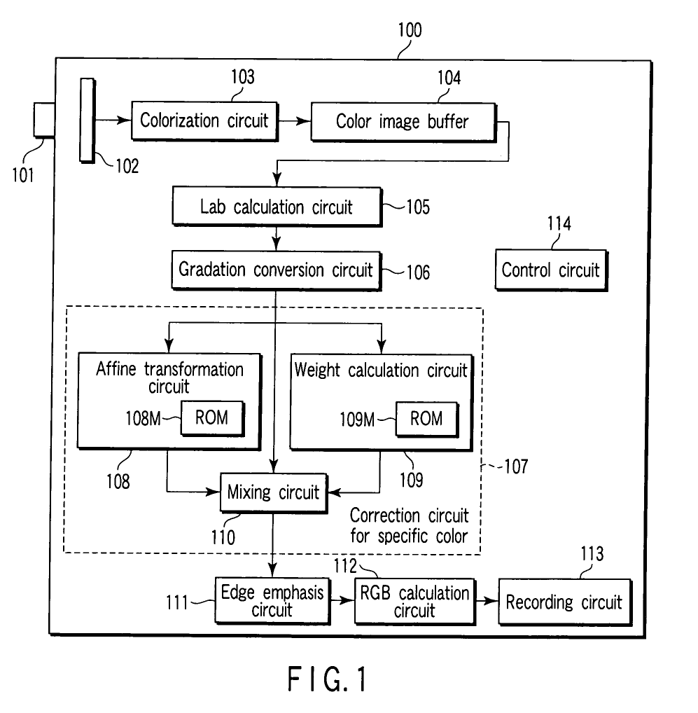

As shown in FIG. 1, a digital camera 100 serving as an image processing apparatus according to a first embodiment of the present invention includes an optical system 101, a single-plate CCD 102, a colorization circuit 103, a color image buffer 104, a Lab calculation circuit 105, a gradation conversion circuit 106, a correction circuit 107 for specific color, an edge emphasis circuit 111, an RGB calculation circuit 112, a recording circuit 113, and a control circuit 114.

The colorization circuit 103 applies white balance (WB) processing and interpolation processing to an output from the single-plate CCD 102 to create an RGB color image. The color image buffer 104 stores the output from the colorization circuit 103. The Lab calculation circuit 105 converts color representation of the image in the color image buffer 104 from RGB to L*a*b* which is a uniform color space. The gradation conversion circuit 106 applies gradation conversion to the L*a*b*-converted image sent from the Lab calculation circuit 105. The correction circuit 107 for specific color applies correction to a specific color range in the gradation converted image sent form the gradation conversion circuit 106. The edge emphasis circuit 111 applies edge emphasis to the image sent from the correction circuit 107 for specific color in which a specific color range has been corrected. The RGB calculation circuit 112 converts the edge-emphasized image sent from the edge emphasis circuit 111, which is represented by an L*a*b* color space, into an RGB image based on the color reproduction characteristics of a specific CRT. The recording circuit 113 stores the RGB edge-emphasized image sent from the RGB calculation circuit 112. The control circuit 114 has a role of controlling the above circuits.

The correction circuit 107 for specific color includes an affine transformation circuit 108, a weight calculation circuit 109, and a mixing circuit 110. The affine transformation circuit 108 corrects a specific color range in the gradation-converted image sent from the gradation conversion circuit 106 according to an affine transformation. The mixing circuit 110 calculates the weighted average of a color range that has been affine-transformed by the affine transformation circuit 108 and the specific color range in the image that has been gradation-converted by the gradation conversion circuit 106, i.e., a color range that has not been subjected to the affine-transformation. The weight calculation circuit 109 determines the weight value for use in the calculation of weighted average performed by the mixing circuit 110.

Operation of the digital camera 100 having the above configuration is as follows.

When a not shown shutter button is depressed by a user, an optical image is formed on the single-plate CCD 102 by the optical system 101, and an image having only one type of color component value for each pixel is once stored in the internal buffer of the colorization circuit 103. The colorization circuit 103 performs WB processing for the image in the internal buffer and performs interpolation processing to the resultant image to interpolate the color component that is missing in each pixel to thereby generate an RGB color image, which is stored in the color image buffer 104. After completion of the processing performed by the colorization circuit 103, the Lab calculation circuit 105 sequentially reads out RGB values, pixel by pixel, from the color image in the color image buffer 104 and carries out the following series of processing in units of pixel.

The Lab calculation circuit 105 firstly calculates a CIEXYZ value as follows based on matrix m set therein.
X=m(1,1)×R+m(1,2)×G+m(1,3)×B,
Y=m(2,1)×R+m(2,2)×G+m(2,3)×B,
Z=m(3,1)×R+m(3,2)×G+m(3,3)×B (1)
In the expression m(i,j), i is the row number and j is the column number of the matrix m. M is the maximum value (e.g., 1023 in the case of 10 bits) that the color image in the color image buffer 104 can assume. The matrix m is set such that [1,1,1] is calculated as an XYZ value when an RGB value [M, M, M] is input.

Then, the Lab calculation circuit 105 calculates an L*a*b* value from the above XYZ value according to CIE definition. At this time, [1,1,1] is used as a white XYZ value. The calculated L*a*b* value is output to the gradation conversion circuit 106.

The gradation conversion circuit 106 includes a first Look-Up Table (LUT) for calculating L*′ which is a value after conversion using L* as an index and a second LUT for calculating a scaling value S using L* as an index. Firstly, with respect to the L* value of the L*a*b* value input from the Lab calculation circuit 105, the gradation conversion circuit 106 refers to the first LUT using L* as an index to obtain L*′ which is a value after conversion. Then, with respect to a* and b*, the gradation conversion circuit 106 refers to the second LUT using L* as an index to obtain a scaling value S and, based on the scaling value S, calculates a*′ and b*′ according to the following equation (2).
a*′=S×a*,
b*′=S×b* (2)
L*′, a*′, and b*′ thus obtained are output to the correction circuit 107 for specific color.

The correction circuit 107 for specific color corrects a color component corresponding to, e.g., skin color of yellow skinned races. When L*′, a*′, and b*′ are input to the correction circuit 107 for specific color, the affine transformation circuit 108 and weight calculation circuit 109 perform the following processing in parallel.

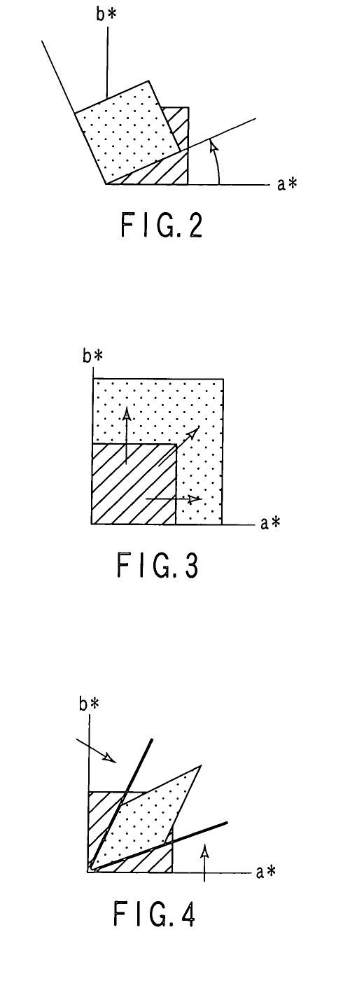

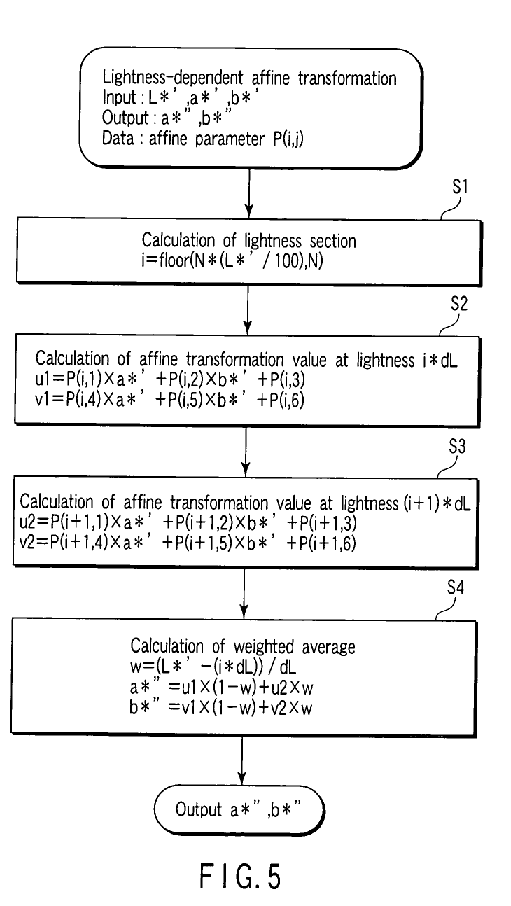

The affine transformation circuit 108 performs different affine transformations for a*′ and b*′ depending on lightness to calculate a*″ and b*″. For that purpose, the affine transformation circuit 108 includes, in the form of a ROM 108M, affine transformation parameters P(i,j) (j is an integer from 1 to 6) for respective lightness values of L*i=i×dL (i is an integer from 0 to N) which are obtained by equally dividing a lightness value into N, where the dL is defined by the following equation: dL=100/N. a*″ and b*″ are calculated using the following equations at a lightness value of L*i.
a*″=P(i,1)×a*′+P(i,2)×b*′+P(i,3),
b*″=P(i,4)×a*′+P(i,5)×b*′+P(i,6) (3)
According to the affine transformation represented by the above equations, it is possible to realize the hue rotation as shown in FIG. 2, saturation emphasis as shown in FIG. 3, and hue uniformity as shown in FIG. 4 without explicitly calculating the hue and saturation. The saturation emphasis degree can also be controlled based on the hue.

Further, with respect to a general lightness L*′ other than the lightness L*i, the processing according to a flowchart shown in FIG. 5 is performed.

That is, the affine transformation circuit 108 firstly calculates to which lightness section set for the affine transformation parameters the input lightness L*′ belongs and obtains an index i (i is an integer from 0 to N−1) in the calculated lightness section (step S1). Incidentally, floor(v,k) is a function that returns the largest integer less than or equal to v but returns k−1 in the case where the largest integer is k.

The affine transformation circuit 108 then calculates a* and b* after affine transformation corresponding to the index i in the lightness section as (u1,v1) (step S2). This calculation is performed using the above equation (3).

After that, the affine transformation circuit 108 calculates a* and b* after affine transformation corresponding to the index i+1 in the lightness section as (u2,v2) (step S3). This calculation is performed using the above equation (3).

Finally, the affine transformation circuit 108 calculates the weighted average of (u1,v1) and (u2,v2) according to the position of the input lightness L*′ in the lightness section (step S4).

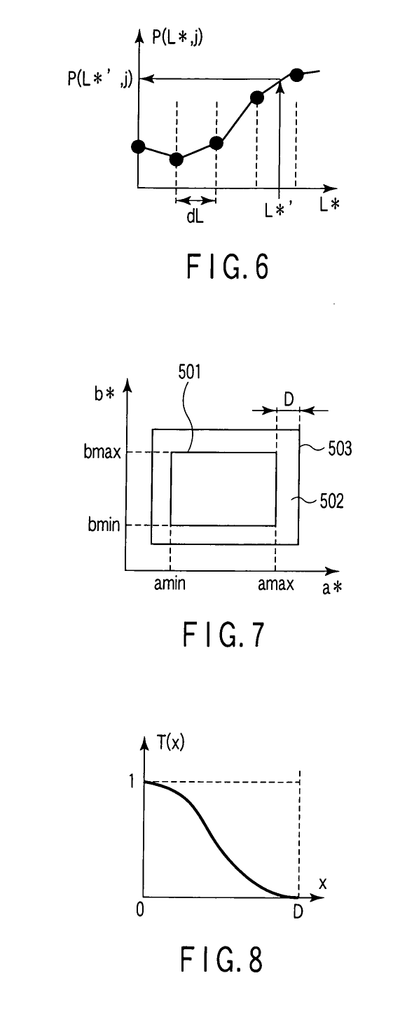

The calculation according to the flowchart of FIG. 5 is, as shown in FIG. 6, equivalent of regarding the affine transformation parameters as a function P(L*,j) of lightness, calculating values P(L*′,j) of respective parameters corresponding to an input lightness L*′ from a value P(i,j) of the discrete P(L*,j) using linear interpolation, and applying a affine transformation.

After calculating a*″ and b*″ according to the affine transformation depending on the input lightness L*′ as described above, the affine transformation circuit 108 outputs obtained a*″ and b*″ to the mixing circuit 110.

The weight calculation circuit 109 calculates, as shown in FIG. 7, a weight having a value of “1” in a correction area 501 specified on an a*b* plane and having a value of “0” outside the correction area 501. Further, in order to prevent discontinuous change at the boundary of the correction area 501, a transition area 502 is provided between an expanded area 503 obtained by expanding the correction area 501 by D along a* and b* axes and correction area 501, and the weight value is gradually decreased from “1” to “0” within the transition area 502. In the present embodiment, the correction area 501 is a rectangular area specified by parameters amin, amax and bmin, bmax. These values of amin, amax, bmin, bmax, and D are stored in an ROM 109M in the weight calculation circuit 109. The weight calculation circuit 109 holds also data of a function T(x) shown in FIG. 8 in the ROM 109M and calculates a weight w for values of a*′ and b*′ that are input using the following equation (4). The calculated w(a*′,b*′) is output to the mixing circuit 110.

$$w = W ( {a}^{* ′} , a min , a max , D ) \times W ( {b}^{* ′} , b min , b max , D ) \\ W ( x , x min , x max , d ) = \{ \begin{matrix} 1 & ( x min \leq x \leq x max ) \\ T ( x - x max ) & \\ & ( x max \leq x \leq x max + d ) \\ T ( x min - x ) & \\ & ( x min - d \leq x \leq x min ) \\ 0 & ( x > x max + d or x < x min - d )\end{matrix} \qquad ( 4 )$$

The mixing circuit 110 calculates final outputs L*′″, a*′″, and b*′″ of the correction circuit 107 for specific color from a*″ and b*″ input from the affine transformation circuit 108, weight w input from the weight calculation circuit 109, and L*′, a*′ and b*′ input from the gradation conversion circuit 106 according to the following equation (5).
L*′″=L*′,
a*′″=w×a*″+(1−w)×a*′,
b*′″=w×b*″+(1−w)×b*′ (5)

L*′″, a*′″, and b*′″ calculated as described above are input to the edge emphasis circuit 111 and subjected to edge emphasis. Finally, the edge-emphasized values are converted into an RGB value in the RGB calculation circuit 112 and, after that, stored in a not-shown internal buffer of the recording circuit 113. More specifically, the RGB calculation circuit 112 converts the input L*a*b* value into an RGB value (R′,G′,B′) needed for reproduction of the L*a*b* value on a given CRT. For that purpose, the RGB calculation circuit 112 firstly calculates a XYZ value from the input L*a*b* value according to CIE definition and converts the XYZ value into an RGB value using the following equation (6), where c is a matrix representing the color reproduction characteristics of a CRT, γ is γ-characteristics of the CRT, and α is a constant number (255, in general) depending on the number of bits of the CRT.
R′=α×(c(1,1))×X+c(1,2)×Y+c(1,3)×Z)ˆγ,
G′=α×(c(2,1))×X+c(2,2)×Y+c(2,3)×Z)ˆγ,
B′=α×(c(3,1))×X+c(3,2)×Y+c(3,3)×Z)ˆγ (6)

The recording circuit 113 performs compression processing every time an RGB value corresponding to a predetermined number of pixels are stored in a not shown buffer thereof, and compression results are sequentially recorded in a not-shown recording medium. After completion of the above processing for all pixels, compression data of a color image in which specific color range has been favorably corrected is stored in the recording medium.

### Second Embodiment

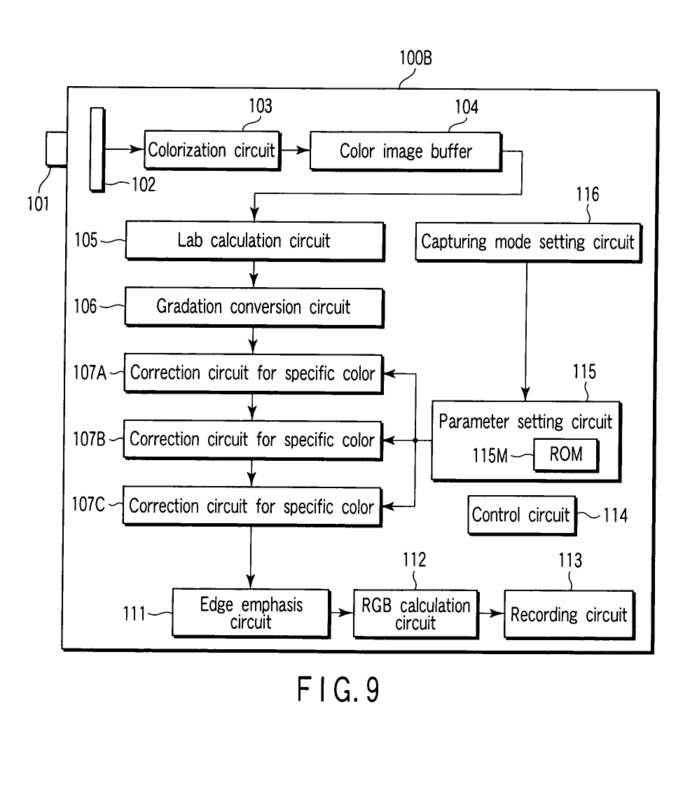

A digital camera 100B serving as an image processing apparatus according to a second embodiment of the present invention has a configuration as shown in FIG. 9. In FIG. 9, the same reference numerals as those in the first embodiment denote the same or corresponding parts as those in FIG. 1, and the descriptions thereof will be omitted here.

The digital camera 100B according to the second embodiment includes a plurality of correction circuits 107A, 107B, and 107C for specific color, which are serially connected. The digital camera 100B further includes a capturing mode setting circuit 116 and a parameter setting circuit 115. The capturing mode setting circuit 116 works with a not-shown user interface and holds capturing mode information indicating the capturing mode that has been selected from among a plurality of capturing modes such as a portrait mode or landscape mode. Although each of the correction circuits 107A to 107C for specific color has the same circuit configuration as that of the correction circuit 107 for specific color shown in FIG. 1, affine transformation parameters and parameters for correction area are set by the parameter setting circuit 115. Although three correction circuits for specific color are provided in the configuration shown in FIG. 9, any number of correction circuits for specific color may be provided, including one, according to need. The parameter setting circuit 115 holds sets of affine transformation parameters and parameters for correction area to be supplied to the respective correction circuits 107A to 107C for specific color depending on the capturing mode in an internal ROM 115M.

After depression of a shutter button, the parameter setting circuit 115 reads out the current capturing mode information held in the capturing mode setting circuit 116 and outputs parameters corresponding to the current capturing mode to the correction circuits 107A to 107C for specific color. Each of the correction circuits 107A to 107C performs correction for a signal of each pixel every time it passes therethrough according to the input parameters and outputs a correction result to a subsequent circuit. As a result, an image in which a plurality of specific color ranges have been corrected is recorded in a recording medium through the recording circuit 113. As an example of a favorable parameter setting made by the parameter setting circuit 115, a pattern that corrects three colors of skin color of yellow skinned races, sky-color, and plant-green and corrects a color that most needs to be corrected in accordance with a capturing mode (skin color in the case where a portrait mode has been selected, for example) using the last correction circuit 107C for specific color is given. It is more preferable if the correction pattern can be freely set from outside. Further, a plurality of skin colors may previously prepared. In this case, it is only necessary to select a desirable color from the prepared skin colors.

### Third Embodiment

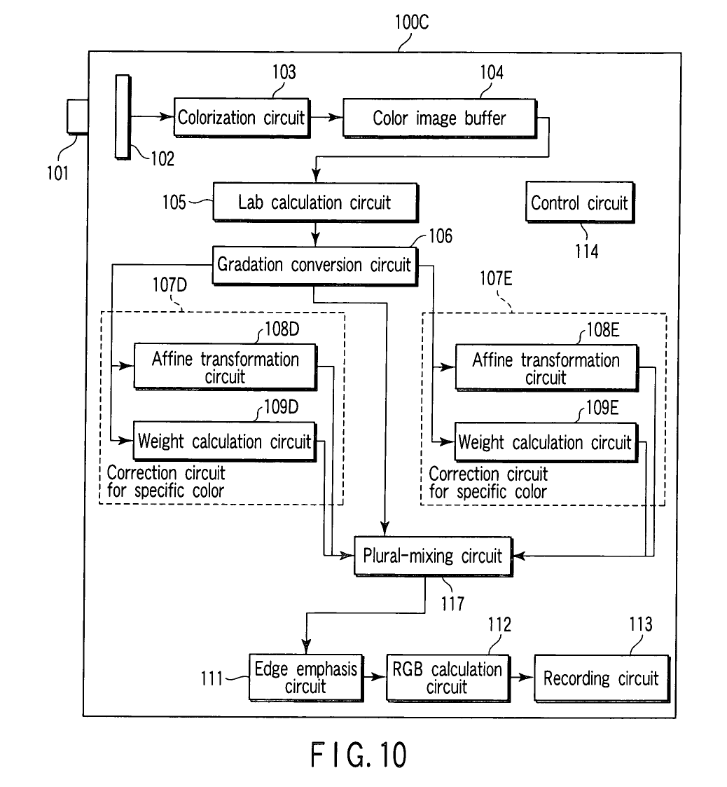

A digital camera 100C serving as an image processing apparatus according to a third embodiment of the present invention has a configuration as shown in FIG. 10. In FIG. 10, the same reference numerals as those in the first embodiment denote the same or corresponding parts as those in FIG. 1, and the descriptions thereof will be omitted here.

The digital camera 100C according to the third embodiment also includes a plurality of correction circuits 107D and 107E for specific color. However, each of the correction circuits 107D and 107E for specific color does not include a circuit corresponding to the mixing circuit 110, but instead the digital camera 100C includes a plural-mixing circuit 117. The correction circuits 107D and 107E for specific color receive the same output from the gradation conversion circuit 106 in parallel and calculate corrected a* and b* using the affine transformation circuits 108D and 108E as well as calculate a weight for determining the correction degree using weight calculation circuits 109D and 109E. After that, the correction circuits 107D and 107E for specific color output a result of the calculation to the plural-mixing circuit 117. The plural-mixing circuit 117 also receives an output directly from the gradation conversion circuit 106 and calculates a final L*a*b* value from all the input values.

Although only two correction circuits for specific color are provided in the configuration shown in FIG. 10, any number of correction circuits for specific color may be provided, if needed. Assume that K correction circuits for specific color are provided, and that a*_i and b*_i are output as values of affine-transformed a* and b* and wi (i is integer from 1 to K) is output as a weight indicating the correction degree from the respective correction circuits. In this case, when receiving L*, a*, and b* from the gradation conversion circuit 106, the plural-mixing circuit 117 calculates final values of L*_fin, a*_fin, and b*_fin according to the following equation (7).

$${L}^{*} \_fin = {L}^{*} , \\ {a}^{*} \_fin = ( \sum wi \times ( {a}^{*} \_i - {a}^{*} ) ) / ( \sum wi ) + {a}^{*} , \\ {b}^{*} \_fin = ( \sum wi \times ( {b}^{*} \_i - {b}^{*} ) ) / ( \sum wi ) + {b}^{*} \qquad ( 7 )$$

where the sum of “i”s is an integer from 1 to K.

As a matter of course, the digital camera according to the second or third embodiment may use only a single correction circuit for specific color in place of using plural correction circuits. In this case, the correction circuit for specific color performs calculation in repetitious fashion while changing only parameters.

### Fourth Embodiment

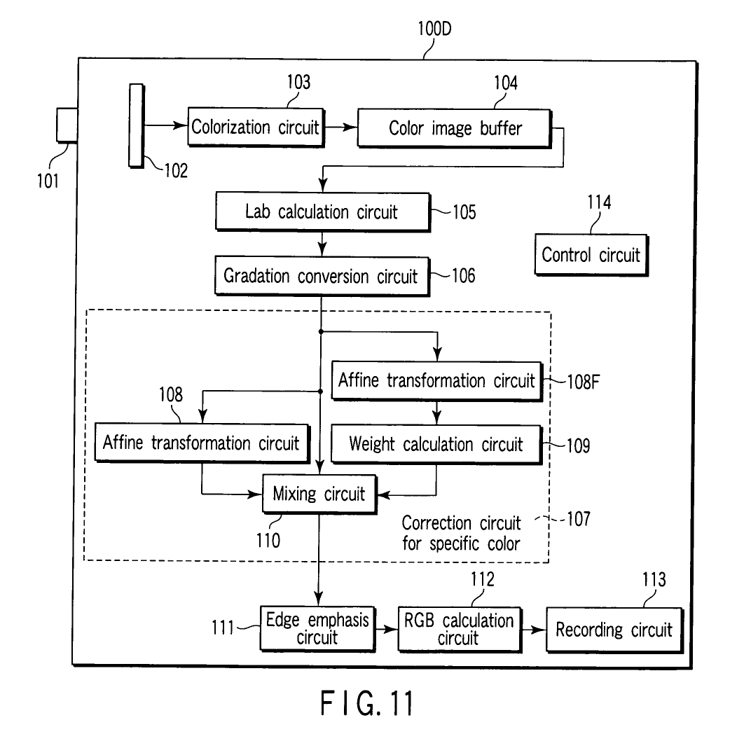

A digital camera 100D serving as an image processing apparatus according to a fourth embodiment of the present invention has a configuration as shown in FIG. 11. In FIG. 11, the same reference numerals as those in the first embodiment denote the same or corresponding parts as those in FIG. 1, and the descriptions thereof will be omitted here.

The fourth embodiment differs from the first embodiment in that the affine transformation circuit 108F is additionally provided between the weight calculation circuit 109 and gradation conversion circuit 106. Although the affine transformation circuit 108F has the same circuit configuration as that of the affine transformation circuit 108, it may have different affine transformation parameters from those of the affine transformation circuit 108. By performing an affine transformation at the front stage of the weight calculation circuit 109, it is possible to limit the correction application area not only to a rectangle in an a*b* plane but also to a shape obtained by affine transforming the rectangle to apply correction. In the case where the affine transformation parameters of the affine transformation circuit 108F is same as those of the affine transformation circuit 108, the input of the weight calculation circuit 109 is taken not from the output of the gradation conversion circuit 106 but from the output of the affine transformation circuit 108 and, in this case, the affine transformation circuit 108F need not be provided.

A further modification may be made to any of the above-described second to fourth embodiments.

For example, the weight for determining the correction degree calculated by the weight calculation circuit 109 or the like may be obtained, in place of using the above equation (4), from a LUT storing weight values for discrete value sets of (a*, b*) using a known bilinear interpolation method.

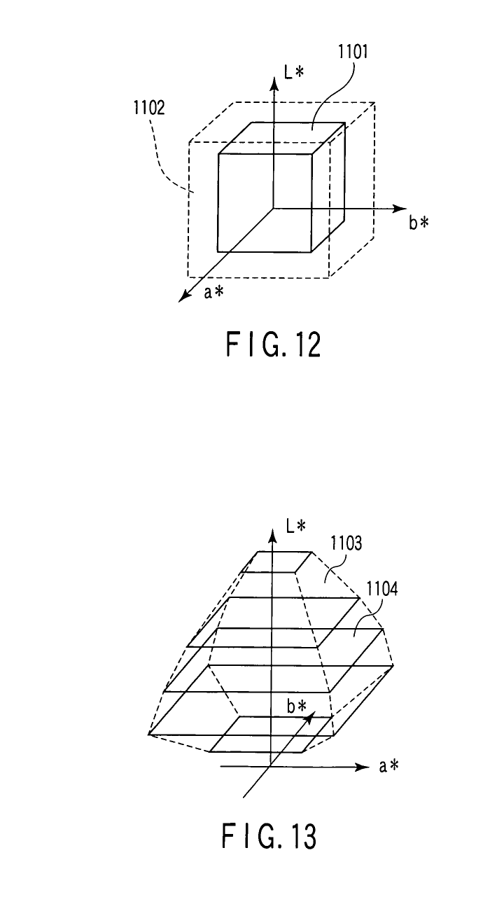

Further, in the case where the correction area is set in the lightness direction, by using the following equation:
w=W(a*′,amin,amax,D)×W(b*′,bmin,bmax,D)×W(L*′,lmin,lmax,D) (8)
obtained by modifying the above equation (4), it is possible to set a rectangular-solid shaped color correction area 1101 as shown in FIG. 12 in the L*a*b* color space. In this case, the transition area 1102 is defined between an area denoted by dotted lines obtained by enlarging the color correction area 1101 by ±D and the color correction area 1101.

Further, by making the correction area 501 in the a*b* plane that is determined by the four parameters of amin, amax, bmin, and bmax shown in FIG. 7 changeable depending on lightness L*′, it is possible to flexibly set the color correction area 1103 as shown in FIG. 13. More specifically, values corresponding to discrete values of L* are held as a one-dimensional table for the respective parameters, and a rectangle 1104 representing the color correction area at each lightness is defined. After that, a known table interpolation method is used to calculate a value for an arbitrary L*.

### Fifth Embodiment

Although the first to fourth embodiments are realized by a hardware circuit configuration, the abovementioned color correction can be realized by software processing.

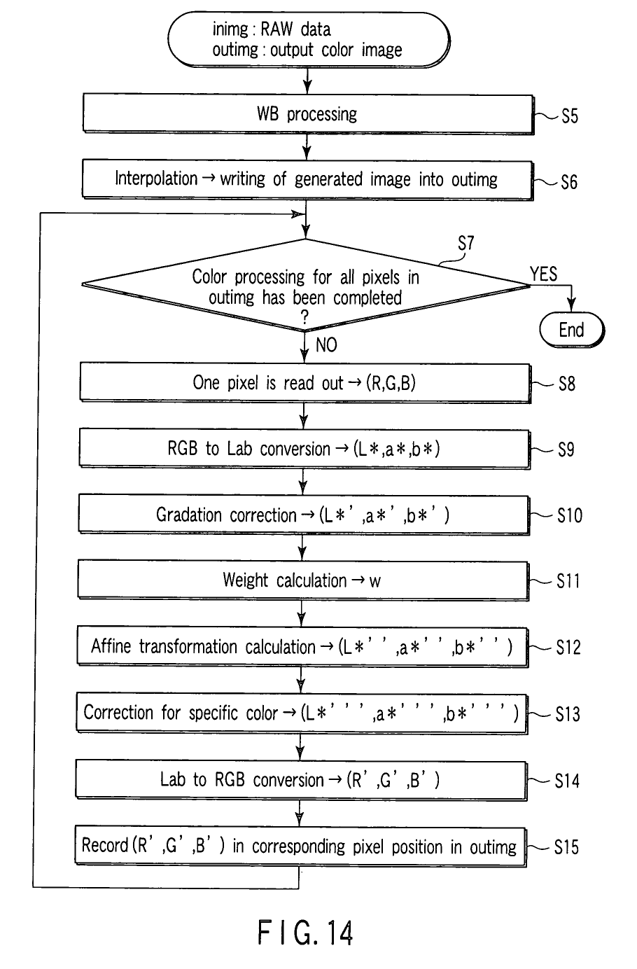

FIG. 14 is a flowchart of image processing performed by software, which shows an image processing method and an image processing program according to a fifth embodiment of the present invention. This software processing applies development processing to RAW data (data obtained by directly recording a signal from the single-plate CCD after analog-to-digital conversion) output from a digital camera and corrects a specific color range as part of the development processing.

Hereinafter, respective steps of the flowchart will be described.

Firstly, WB correction is performed for the RAW data (step S5).

A known interpolation method is used to generate a three-color image from the WB corrected RAW data, and the generated image is written into an output buffer outimg (step S6).

Then, it is determined whether color processing for all pixels in the output buffer outimg has been completed (step S7). If color processing for all the pixels has been completed, this flow is ended; otherwise, the flow advances to step S8.

In step S8, one unprocessed pixel is read out from the output buffer outimg to obtain the RGB value thereof (step S8).

After that, the RGB value obtained in step S8 is converted into an L*a*b* value (step S9). More specifically, a matrix set in the software is used to convert the RGB value into an XYZ value according to the above equation (1), and a CIE definition is used to calculate the L*a*b* value.

Then, gradation conversion is applied to L*, a*, and b* obtained in step S9 (step S10). The processing performed in step S10 is same as that performed by the gradation conversion circuit 106 shown in FIG. 1. That is, L*′ after gradation conversion is calculated from L* based on LUT data set in the software, and a*′ and b*′ are calculated using the above equation (2).

A weight calculation which is same as that performed by the weight calculation circuit 109 of FIG. 1 is then performed based on L*′, a*′, and b*′ obtained in step S10 (step S11). The above-described equation (4) is used for this calculation.

An affine transformation is then applied to L*′, a*′, and b*′ obtained in step S10 to perform the same calculation as that performed by the affine transformation circuit 108 of FIG. 1 to thereby obtain L*″, a*″, and b*″ as values after conversion (step S12). The flowchart of FIG. 5 is used for this calculation. Affine transformation parameters P(i,j) are previously set in the software as data.

After that, L*′″, a*′″, and b*′″, which are components of an L*a*b* value in which a specific color range has been subjected to correction, are calculated from L*″, a*″, and b*″ obtained in step S12, w obtained in step S11 and L*′, a*′ and b*′ obtained in step S10 using the above equation (5) (step S13).

Then, R′, G′, and B′, which are components of an RGB value needed for representing a color range specified by the L*a*b* value on a given CRT, are calculated from L*′″, a*′″, and b*′″ obtained in step S13 (step S14). The calculation performed in step S14 is same as that performed by the RGB calculation circuit 112.

Finally, R′, G′, and B′ obtained in step S14 are written in the corresponding pixel position on the image in the output buffer outimg as a value resulting from color correction for the pixel read out in step S8 (step S15). After that, the flow returns to step S7.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. An image processing apparatus comprising:
a first correction section configured to correct a component of an input color signal represented by a plurality of components including a lightness component, the component to be corrected being other than the lightness component;
a parameter setting section configured to set parameters of the first correction section depending on the lightness component of the input color signal;
an adjusted value calculation section configured to calculate an adjusted value for determining the final degree of color correction depending on one of the input color signal and a correction result of the first correction section; and
a second correction section configured to correct the input color signal based on the correction result of the first correction section, input color signal, and adjusted value of the adjusted value calculation section and output a final color correction result.

2. An image processing apparatus which performs color correction for an input color signal represented by a plurality of components including a lightness component, comprising:
first to N-th (N is an integer equal to or more than 2) color correction sections each configured to perform color correction for a specific color range, wherein
the first color correction section is configured to apply processing to the input color signal as an input color signal thereof,
the i-th (i is an integer from 2 to N) color correction section is configured to apply processing to an output from the (i−1)-th color correction section as an input color signal, and
each color correction section includes:
a first correction section configured to correct a component of a color signal input to the color correction section, the component to be corrected being other than the lightness component;
a parameter setting section configured to set parameters of the first correction section depending on the lightness component of the color signal input to the color correction section;
an adjusted value calculation section configured to calculate an adjusted value for determining the final degree of color correction depending on one of the color signal input to the color correction section and a correction result of the first correction section; and
a second correction section configured to correct the input color signal based on the correction result of the first correction section, color signal input to the color correction section, and adjusted value of the adjusted value calculation section and output a final color correction result.

3. An image processing apparatus which performs color correction for an input color signal represented by a plurality of components including a lightness component, comprising:
first to N-th (N is an integer equal to or more than 2) color correction sections each configured to perform color correction for a specific color range; and
a final color correction section configured to output a final color correction result based on outputs of the respective color correction section and input color signal,
each of the color correction section including:
a first correction section configured to correct a component of the input color signal, the component to be corrected being other than the lightness component;
a parameter setting section configured to set parameters of the first correction section depending on the lightness component of the input color signal; and
an adjusted value calculation section configured to calculate an adjusted value for determining the final degree of color correction depending on one of the input color signal and a correction result of the first correction section, the color correction section outputting the correction result of the first correction section and adjusted value of the adjusted value calculation section.

4. The image processing apparatus according to claim 1, wherein correction parameters of the correction section include coefficients of an affine transformation.

5. The image processing apparatus according to claim 2, wherein correction parameters of the correction section include coefficients of an affine transformation.

6. The image processing apparatus according to claim 3, wherein correction parameters of the correction section include coefficients of an affine transformation.

7. The image processing apparatus according to claim 1, wherein the adjusted value calculation section comprises:
an area setting section configured to set a first area and a second area encompassing the first area in a color space representing the input color signal; and
a calculation section configured to define a predetermined continuous function f which is “1” within the first area and “0” outside the second area and calculate a value f(x) of the continuous function corresponding to a value x of the input color signal as adjusted value.

8. The image processing apparatus according to claim 2, wherein the adjusted value calculation section comprises:
an area setting section configured to set a first area and a second area encompassing the first area in a color space representing the input color signal; and
a calculation section configured to define a predetermined continuous function f which is “1” within the first area and “0” outside the second area and calculate a value f(x) of the continuous function corresponding to a value x of the input color signal as adjusted value.

9. The image processing apparatus according to claim 3, wherein the adjusted value calculation section comprises:
an area setting section configured to set a first area and a second area encompassing the first area in a color space representing the input color signal; and
a calculation section configured to define a predetermined continuous function f which is “1” within the first area and “0” outside the second area and calculate a value f(x) of the continuous function corresponding to a value x of the input color signal as adjusted value.

10. The image processing apparatus according to claim 7, wherein
with the dimension of a color space representing the input color signal set as M, the area setting section sets the first and second areas in the form of a M-dimensional rectangular solid in a color space representing the input color signal.

11. The image processing apparatus according to claim 8, wherein
with the dimension of a color space representing the input color signal set as M, the area setting section sets the first and second areas in the form of a M-dimensional rectangular solid in a color space representing the input color signal.

12. The image processing apparatus according to claim 9, wherein
with the dimension of a color space representing the input color signal set as M, the area setting section sets the first and second areas in the form of a M-dimensional rectangular solid in a color space representing the input color signal.

13. The image processing apparatus according to claim 7, wherein
the dimension of a color space representing the input color signal is 3, and
the area setting section sets the first and second areas in the form of a rectangle for the components other than a lightness component and changes the boundary of the rectangle depending on the lightness component.

14. The image processing apparatus according to claim 8, wherein
the dimension of a color space representing the input color signal is 3, and
the area setting section sets the first and second areas in the form of a rectangle for the components other than a lightness component and changes the boundary of the rectangle depending on the lightness component.

15. The image processing apparatus according to claim 9, wherein
the dimension of a color space representing the input color signal is 3, and
the area setting section sets the first and second areas in the form of a rectangle for the components other than a lightness component and changes the boundary of the rectangle depending on the lightness component.

16. The image processing apparatus according to claim 7, wherein the adjusted value calculation section includes a coordinate transformation section configured to perform coordinate transformation for the input color signal and determines the final degree of color correction depending on a color signal obtained through the coordinate transformation performed by the coordinate transformation section.

17. The image processing apparatus according to claim 8, wherein the adjusted value calculation section includes a coordinate transformation section configured to perform coordinate transformation for the input color signal and determines the final degree of color correction depending on a color signal obtained through the coordinate transformation performed by the coordinate transformation section.

18. The image processing apparatus according to claim 9, wherein the adjusted value calculation section includes a coordinate transformation section configured to perform coordinate transformation for the input color signal and determines the final degree of color correction depending on a color signal obtained through the coordinate transformation performed by the coordinate transformation section.

19. The image processing apparatus according to claim 16, wherein the coordinate transformation performed by the coordinate transformation section is an affine transformation to be applied to a component other than a lightness component.

20. The image processing apparatus according to claim 17, wherein the coordinate transformation performed by the coordinate transformation section is an affine transformation to be applied to a component other than a lightness component.

21. The image processing apparatus according to claim 18, wherein the coordinate transformation performed by the coordinate transformation section is an affine transformation to be applied to a component other than a lightness component.

22. The image processing apparatus according to claim 1, wherein the second correction section calculates the weighted average of a correction result of the first correction section and input color signal based on the adjusted value to obtain a final color correction result.

23. The image processing apparatus according to claim 2, wherein the second correction section calculates the weighted average of a correction result of the first correction section and input color signal based on the adjusted value to obtain a final color correction result.

24. The image processing apparatus according to claim 3, wherein the final correction section calculates a ratio wi′ (i is integer from 1 to N) relative to a total sum Σwi of the adjusted values wi output from all the color correction section and obtains a final color correction result based on a value obtained by calculating the weighted average of a color correction result output from i-th color correction section using the calculated ratio wi′.

25. The image processing apparatus according to claim 1, wherein the parameter setting section includes a holding section configured to hold parameters corresponding to discrete lightness values as fundamental parameters and calculate parameters corresponding to an arbitrary lightness value based on the held fundamental parameters.

26. The image processing apparatus according to claim 2, wherein the parameter setting section includes a holding section configured to hold parameters corresponding to discrete lightness values as fundamental parameters and calculate parameters corresponding to an arbitrary lightness value based on the held fundamental parameters.

27. The image processing apparatus according to claim 3, wherein the parameter setting section includes a holding section configured to hold parameters corresponding to discrete lightness values as fundamental parameters and calculate parameters corresponding to an arbitrary lightness value based on the held fundamental parameters.

28. The image processing apparatus according to claim 25, wherein the parameter setting section
holds a plurality of sets of fundamental parameters in the holding section and
further includes a mode setting section by which it is possible to select, from outside, an arbitrary set from among the plurality of sets held in the holding section.

29. The image processing apparatus according to claim 26, wherein the parameter setting section
holds a plurality of sets of fundamental parameters in the holding section and
further includes a mode setting section by which it is possible to select, from outside, an arbitrary set from among the plurality of sets held in the holding section.

30. The image processing apparatus according to claim 27, wherein the parameter setting section
holds a plurality of sets of fundamental parameters in the holding section and
further includes a mode setting section by which it is possible to select, from outside, an arbitrary set from among the plurality of sets held in the holding section.

31. An image processing method comprising:
correcting a component of an input color signal represented by a plurality of components including a lightness component, the component to be corrected being other than a lightness component;
setting parameters for correction of the component other than the lightness component depending on the lightness component of the input color signal;
calculating an adjusted value for determining the final degree of color correction depending on one of the input color signal and a result of the correction; and
correcting the input color signal based on the correction result, input color signal, and adjusted value and outputting a final color correction result.

32. An image processing program allowing a computer to execute processes of:
correcting a component of an input color signal represented by a plurality of components including a lightness component, the component to be corrected being other than a lightness component;
setting parameters for correction of the component other than the lightness component depending on the lightness component of the input color signal;
calculating an adjusted value for determining the final degree of color correction depending on one of the input color signal and a result of the correction; and
correcting the input color signal based on the correction result, input color signal, and adjusted value and outputting a final color correction result.
